(19) United States
(12) Patent Application Publication
(10) Pub. No.: US 2015/0158615 A1
(43) Pub. Date: Jun. 11, 2015

(54) Bag Binder

(71) Applicant: Ken Downs, Bakersfield, CA (US)

(72) Inventor: Ken Downs, Bakersfield, CA (US)

(21) Appl. No.: 14/567,283

(22) Filed: Dec. 11, 2014

Related U.S. Application Data
(60) Provisional application No. 61/914,553, filed on Dec. 11, 2013.

(51) Int. Cl. B65B 67/12; A44B 11/12; B65F 1/14; A44B 11/06

(52) U.S. Cl. CPC B65B 67/1233; A44B 11/065; A44B 11/125; B65F 1/14

(57) ABSTRACT

The bag binder system is adaptable to a variety of trash cans and securely fastens a trash bag to a trash can and allows a user to quickly and easily change the trash bag when needed. The bag binder system includes a high-friction strap with one end threaded through a two-hole retaining clip and attached to one end of an adjustable strap lock assembly whereas the opposite end of the high-friction strap is threaded through and attached to the alternative end of the adjustable strap lock assembly to create a closed loop. The two-hole retaining clip allows adjustability of the high-friction strap to accommodate a variety of trash can shapes and sizes. The adjustable strap lock assembly quickly locks or releases the tension created in the high-friction strap. The combination of tension and grip provided by the high-friction strap securely fastens the trash bag to the trash can.

### RELATED APPLICATIONS

This application is a conversion of, and claims the benefit of priority to, the United States Provisional Patent Application for “Bag Binder,” Ser. No. 61/914,553, filed on Dec. 11, 2013, and currently co-pending.

### FIELD OF INVENTION

The present invention relates generally to trash bag binders. The present invention is more particularly, though not exclusively, related to a bag binder system which integrates a high-friction strap, a retaining clip and an adjustable strap lock to allow a user to lock a strap securely around a trash bag to secure the trash bag against the outer surface of a trash can.

### BACKGROUND OF INVENTION

Typical trash cans have walls extending from a base to an opening having an outer lip that is slightly larger than the wall's outer surface. The trash cans can be various shapes and sizes, such as a cylinder or rectangle. Trash bags are ordinarily placed in a trash can with the open end of the trash bag folded over the outer lip of the trash can and secured to the outer surface of the trash can. Often, the open ended edge of the bag itself is tied in a knot around the outer surface of the trash can in an effort to keep the trash bag taut and in place. Alternatively, trash bags with built in straps around the open end can be secured to a trash can by tying the built in straps around the outer surface of the trash can. In either instance, the goal is to securely place trash bags in a trash can in such a manner so as to keep the bag from falling into the can when trash is deposited into the trash bag. However, in both instances, the knots are insufficient to secure the trash bag and often the trash bag falls into the trash can. Further, trash bags with built in straps are more expensive than conventional garbage bags.

Securing trash bags becomes even more complicated when dealing with larger trash cans and trash bags, such as are used by janitorial services. The weight of the trash placed into the larger trash bags often causes the trash bag to fall into the can. Additionally, the constant repetitive use of the trash can may dislodge the trash bag. Once the trash bag is dislodged and falls into the can, the trash bag can spill its contents into the trash can itself. In addition, the outer surface of the trash bag can become soiled with garbage, requiring users to needlessly expose themselves to garbage.

In light of the above, it would be advantageous to provide a bag binder system which has the ability to securely attach a garbage bag to the outer surface of a garbage can. It would further be advantageous to provide a bag binder capable of securing and supporting a trash bag and its contents, ensuring the weight of garbage cannot cause the garbage bag to fall into the garbage can. It would further be advantageous to provide a bag binder system with a high friction surface to adequately grip the surface of a garbage bag to prevent the garbage bag from sliding free. It would be further advantageous to provide a bag binder system that is robust and can be used repeatedly. It would be further advantageous to provide a bag binder system that is easy to use and adaptable to be used for all sizes and geometries of garbage cans, both in residential and commercial applications.

### SUMMARY OF THE INVENTION

The bag binder system is an integrated solution for anyone with a trash can, ranging from home use to use by commercial janitorial service providers. The bag binder system is easy to use, compact, and mobile. The bag binder system includes a high-friction strap, a two-hole retaining clip, and an adjustable strap lock assembly.

The adjustable strap lock assembly has an adjustable strap lock base and an adjustable strap lock lever. The adjustable strap lock base has a first transverse bar and a second transverse bar positioned so as to create a first end aperture. The adjustable strap lock base also has a base plate positioned so as to create a middle aperture between the second transverse bar and the base plate. The adjustable strap lock base also has a rear end formed to create a second end aperture. Vertically extending from the long edge of the adjustable strap lock base are two support walls. The support walls each have a hole to receive pegs of the adjustable strap lock lever to allow the adjustable strap lock lever to be rotatably attached to the adjustable strap lock base about the pegs.

The adjustable strap lock lever has a back curved surface, a gripping end, a front end, a top surface, a bottom surface and sides. A peg protrudes from each side of the adjustable strap lock lever. The pegs of the adjustable strap lock lever are inserted into the holes formed in the support walls of adjustable strap lock base to form the adjustable strap lock assembly. The adjustable strap lock lever can then be rotated along the axis of its pegs to an open position with respect to the strap lock base. The adjustable strap lock lever can also be rotated along the axis of its pegs to a locked position with respect to the strap lock base. When the adjustable strap lock lever is in the open position, the back end is placed directly over the base plate such that a pass through opening is created. The pass through opening is sized to enable a strap to easily pass through the pass through opening. When the adjustable strap lock lever is in the locked position, the gripping end is placed directly over the base plate such that a locking channel is created. The locking channel is sized to create an interference fit between the strap and the locking channel to apply a compression force to secure the strap within the locking channel.

To use the bag binder system, a user first places a trash bag in a trash can and folds the open end of the trash bag over the lip of the opening of the trash can. Next, a user takes the first end of the strap and passes it through the second hole of the two-hole retaining clip, around the top of the two hole retaining clip and then passes the first end of the strap through the second hole of the two hole retaining clip. With the adjustable strap lock lever in the open position, the user then passes the first end of the strap through the first end aperture of the adjustable strap lock base, wraps the first end of the strap around the first transverse bar and passes the first end of the strap back through the two hole retaining clip such that a strap loop is created between the two hole retaining clip and the front of the strap lock assembly.

While the adjustable strap lock lever remains in the open position, the user then passes the second end of the strap first through the second end aperture towards the bottom of adjustable strap lock base. Next, the user then passes the second end of the strap through the middle aperture of the adjustable strap lock base up towards the top surface of the adjustable strap lock base. The user then passes the second end of the strap through the pass through opening of the adjustable strap lock assembly.

Next, the user pulls the second end of the strap until the strap is in tension and fits tightly against the surface of the folded edge of the trash bag and outer surface of the trash can. Finally, the user rotates the strap lock lever to the locked position. As the user rotates the strap lock lever to the locked position, the back curved surface rotates away from the base plate of the adjustable strap lock and closes the pass through opening. Once the strap lock lever is in the locked position, the strap is bound between the gripping end of the of the adjustable strap lock lever and the base plate thereby maintaining the tension in the strap and ensuring that the trash bag is properly bound to the trash can. The high-friction surface of the strap combined with the tension created by the strap firmly secures the trash bag to the trash can.

When the user wishes to take out the trash, the user simply rotates the strap lock lever from the locked position to the open position thereby creating the pass through opening. A sufficient amount of the strap is then pulled through the pass through opening to remove all tension in the strap to enable the trash bag to be freely removed from the trash can. Alternatively, because the high-friction strap is elastic, a user can remove the Bag Binder by stretching the high-friction strap and pulling the high-friction strap over the outer lip of the trash can. Because the high-friction strap has already been adjusted to the appropriate length for the particular trash can and securely held in place by the strap lock assembly, once a new liner has been placed in the trash can, the user simply re-stretches the high-friction strap over the outer lip of the trash can and then releases the high-friction strap. Once released by the user, the high-friction strap will contract thereby securely holding the trash liner in place.

### BRIEF DESCRIPTION OF DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a plan view of a preferred embodiment of the present invention in use to secure a trash bag folded over the outer surface of a trash can to the trash can;

FIG. 2 is an exploded plan view of the bag binder system showing a high-friction strap, two-hole retainer clip, and adjustable strap lock assembly;

FIG. 3 is a plan view of the present invention configured in the open position to allow adjustability of the length of the high-friction strap to be used with a variety of trash cans having different shapes and sizes;

FIG. 4 is a plan view of the present invention in the locked position and configured to securely fasten a trash bag to a trash can;

FIG. 5 is a cross sectional view of a preferred embodiment of the present invention in the open position along the lines 1-1 as show in FIG. 3;

FIG. 6 is a cross sectional view of a preferred embodiment of the present invention in the locked position along the lines 2-2 as shown in FIG. 4;

FIG. 7a is a side view of an alternative embodiment of the present invention showing a shortened locking lever replacing the standard locking lever;

FIG. 7b is a bottom view of the alternative locking lever showing a flat gripping surface and cut out to facilitate a user opening the locking lever;

FIG. 7c is a top view of the alternative locking lever showing the cut out in dashed lines;

FIG. 8a is a rear view of the adjustable strap lock assembly with the alternative locking lever depicted in FIGS. 7a through 7c with the locking lever in the open position with the pass through opening clearly visible;

FIG. 8b is a rear view of the adjustable strap lock assembly with the alternative locking lever depicted in FIGS. 7a through 7c with the locking lever in the closed position; and

FIG. 9 is a cross-sectional view of the adjustable strap lock assembly with the alternative locking lever depicted in FIGS. 7a through 7c and showing the locking channel between the flat gripping surface and the indent of the base plate.

### DETAILED DESCRIPTION OF A PREFERRED EMBODIMENT

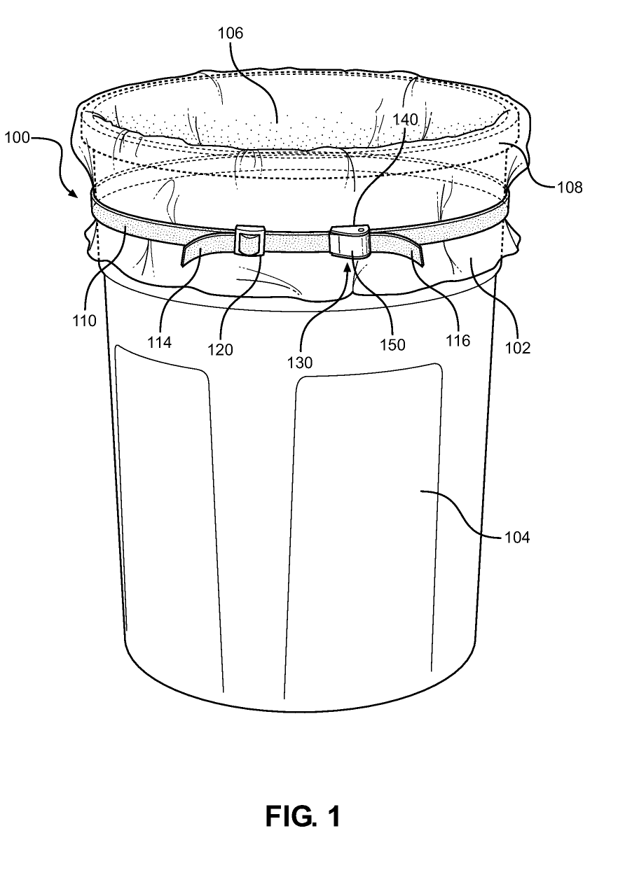

Referring initially to FIG. 1, the preferred embodiment of the present invention, the bag binder system 100 is shown being utilized to secure a trash bag 102 to the outer surface 104 of a trash can 106. The bag binder system 100 has a high-friction strap 110, a two-hole retaining clip 120 and an adjustable strap lock assembly 130.

As depicted in FIG. 1, the trash bag 102 is folded over the outer lip 108 of trash can 106. The high-friction strap 110 is wrapped tightly around trash bag 102 and secures the trash bag 102 to the outer surface 104 of trash can 106. The high-friction strap 110 is locked in place by the adjustable strap lock assembly 130. The high-friction surface of the high-friction strap 110 ensures the strap firmly grips the surface of the trash bag 102 to prevent it from slipping. When the high-friction strap 110 is locked in place by the adjustable strap lock assembly 130, tension in the high-friction strap 110 is maintained such that the trash bag 102 cannot slip out between the strap 110 and the outer surface 104 of the trash can 106. Thus, the trash bag 102 is held firmly in place by the bag binder system 100.

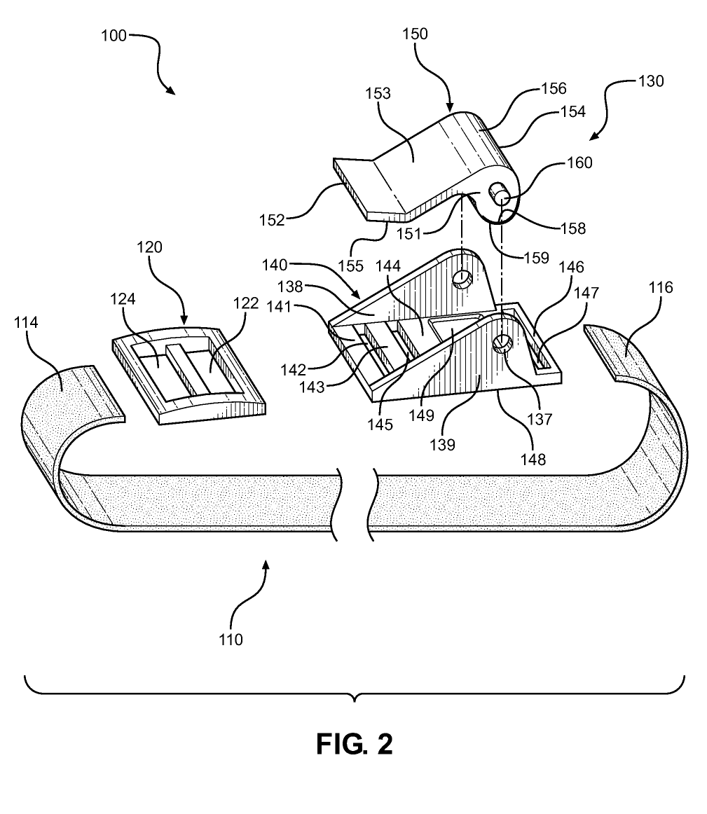

Referring now to FIG. 2, an exploded plan view of the bag binder system 100 is shown. The preferred embodiment of the present invention, the bag binder system 100 includes a high-friction strap 110, a two-hole retaining clip 120, and an adjustable strap lock assembly 130.

The high-friction strap 110 has a first end 114 and a second end 116. In the preferred embodiment, the high-friction strap 110 is made of a durable, pliable rubber or any other material known in the art having similar properties with a high coefficient of friction. Most commercial trash bags are made of polyethylene which has a low coefficient of friction. Due to the low coefficient of friction of the trash bag, a greater amount of downward force and a corresponding high friction contact surface is required to prevent the bag from moving. By combining the high coefficient of friction of the high-friction strap 120 and the downward force created by tensioning the high-friction strap 110, the bag binder system 100 provides sufficient friction force to keep the trash bag in place.

The adjustable strap lock assembly 130 includes the adjustable strap lock lever 150 and the adjustable strap lock base 140. The adjustable strap lock base 140 has a first transverse bar 141 and a second transverse bar 143 positioned between a first support wall 138 and a second support wall 139 so as to create a first end aperture 142 between the first transverse bar 141 and the second transverse bar 143. The adjustable strap lock base 140 also has a base plate 144 formed with indent 149 positioned between the first support wall 138 and the second support wall 139 so as to create a middle aperture 145 between the second transverse bar 143 and the base plate 144. The base plate 144 also has a rear end 146 forming a second end aperture 147 extending past the first support wall 138 and the second support wall 139. The first support wall 138 and the second support wall 139 have holes 137 sized to receive pegs 160 of the adjustable strap lock lever 150.

The adjustable strap lock lever 150 has a front end 152, a top 153, a back end 154, a bottom 155, and sides 151. The back end 154 of the adjustable strap lock lever 150 has a curved back surface 156. The adjustable strap lock lever 150 also has a gripping end 158 with a textured surface 159. It will be apparent to those skilled in the art that the adjustable strap lock lever 150 with the gripping end 158 can be made herein without the textured surface 159 without departing from the scope and spirit of the invention. Formed on each side 151 of the adjustable strap lock lever 150 are pegs 160 sized to be inserted into holes 137 of the adjustable strap lock base 140. In order to form the adjustable strap lock assembly 130, the pegs 160 of adjustable strap lock lever 150 are inserted into the holes 137 of the adjustable strap lock base 140. Once so inserted, the adjustable strap lock lever 150 can be rotated about an axis defined by the pegs 160 of adjustable strap lock lever 150 and holes 137 of the adjustable strap lock base 140.

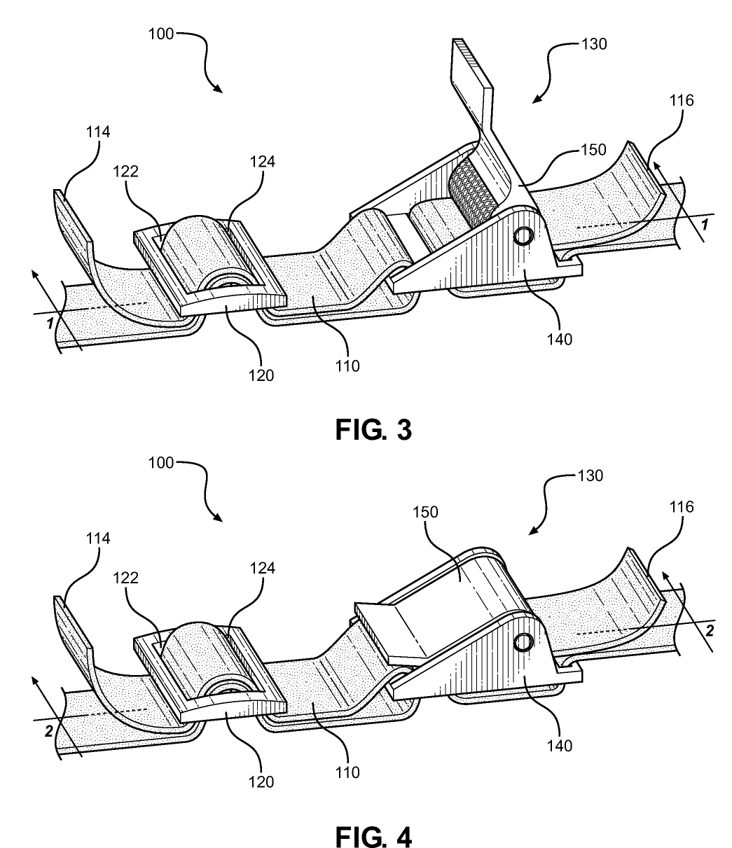

The adjustable strap lock assembly 130 has an open position (shown in FIG. 3) and a locked position (shown in FIG. 4). When the adjustable strap lock lever 150 is in the open position, the back end 154 of the adjustable strap lock lever 150 is placed directly over the base plate 144 of the adjustable strap lock base 140 such that a pass through opening 165 between the base plate 144 formed with indent 149 and the back end 154 is created. The pass through opening 165 is sized to enable the high-friction strap 110 to easily pass through the opening 165. When the adjustable strap lock lever 150 is in the locked position, the gripping end 158 is placed directly over the base plate 144 formed with indent 149 such that a locking channel 167 is created. The locking channel 167 is sized to create an interference fit between the high-friction strap 110 and the locking channel 167 in order for the gripping end 158 of the adjustable strap lock lever 150 to apply a compression force to secure the high-friction strap 110 within the locking channel 167.

The two-hole retaining clip 120 has a first hole 122 and a second hole 124. The first hole 122 and second hole 124 are each sized to receive the high-friction strap 110. The two-hole retaining clip 120 serves as a strap fastener to fasten the first end 114 of the high friction strap 110 to itself after it is passed through the first end aperture 142 of the adjustable strap lock assembly 130. It is to be appreciated that the present invention is not limited to a two-hole retaining clip 120 for use as a strap fastener, and other fasteners known in the art could also be utilized so long as such fasteners are capable of securing the first end 114 of the high friction strap 110 to the high friction strap 110 after the first end 114 is passed through the first end aperture 142 of the adjustable strap lock assembly 130. Such strap fasteners would include clips, snaps, hook and loop fabric sewn on to the high friction strap, etc.

The two-hole retaining clip 120 and the adjustable strap lock assembly 130 are made from a low cost material providing high strength and stiffness, enhanced dimensional stability, and ease of manufacturing, such as acetal plastic. The material used in constructing the preferred embodiment of the two-hole retaining clip 120 and adjustable strap lock assembly 130 of the present invention is not meant to be limiting. Any material known in the art with similar physical properties may be used without departing from the scope and spirit of the present invention.

Referring now to FIG. 3, a close up plan view of the bag binder system 100 is shown in the open position. The bag binder system 100 includes a high-friction strap 110, a two-hole retaining clip 120, and an adjustable strap lock assembly 130. As shown, the adjustable strap lock lever 150 is in the open position to allow the high-friction strap 110 to be adjusted to fit around a trash can 106 (not shown) and trash bag 102 (not shown).

Referring now to FIG. 4, a close up plan view of the bag binder system 100 is shown in the locked position. The bag binder system 100 includes a high-friction strap 110, a two-hole retaining clip 120, and an adjustable strap lock assembly 130. As shown, the adjustable strap lock lever 150 is in the locked position and compresses the high-friction strap 110 against the adjustable strap lock base 140 to prevent the high friction-strap 110 from moving. When the high-friction strap 110 is locked in place by the adjustable strap lock assembly 130, tension in the high-friction strap 110 is maintained to create sufficient friction force to ensure trash bag 102 fitted around a trash can 106 cannot slip out between the high-friction strap 110 and trash can 106.

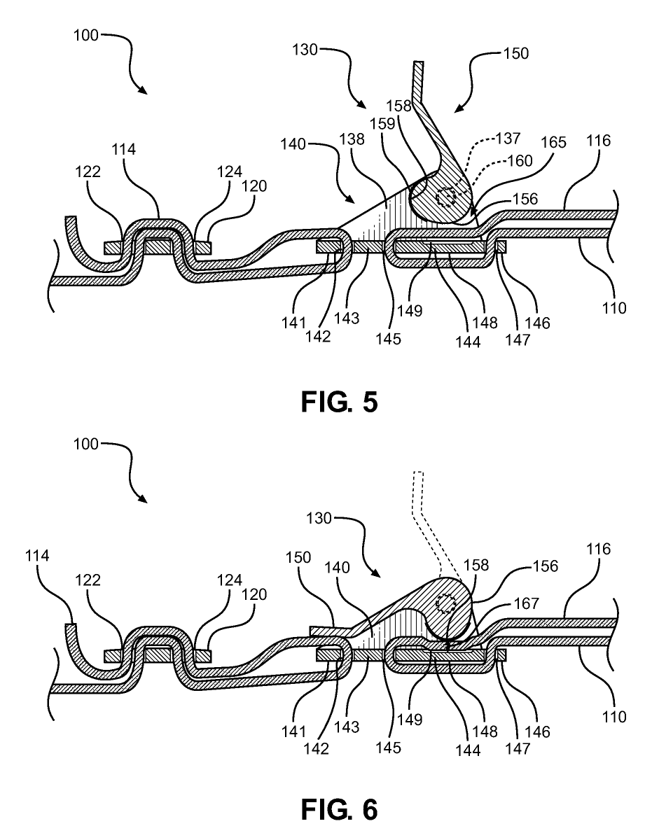

Referring now to FIG. 5, a cross sectional view of the bag binder system 100 along the lines 1-1 of FIG. 3 is shown with the bag binder system 100 in the open position. The bag binder system 100 has a high-friction strap 110, a two-hole retaining clip 120, and an adjustable strap lock assembly 130. As shown, the adjustable strap lock lever 150 is in the open position to allow the high-friction strap 110 to be adjusted to fit around trash can 106.

Referring now to FIG. 6, a cross sectional view of the bag binder system 100 along the lines 2-2 of FIG. 4 is shown with the bag binder system 100 in the locked position. As shown, the strap lock lever 150 is in the locked position such that the high-friction strap 110 is firmly compressed between the indent 149 of the base plate 144 and the gripping end 158 of the strap lock lever 150.

In order to secure trash bag 102 to trash can 106 using the bag binder system 100, a user first places trash bag 102 in trash can 106 and folds the open end of trash bag 102 over the lip of the opening of the trash can 106.

Next, a user takes the first end 114 of the high-friction strap 110 and passes it through the first hole 122 of the two-hole retaining clip 120, around the top of the two hole retaining clip 120 and then passes the first end 114 of the high-friction strap 110 through the second hole 124 of the two hole retaining clip 120. With the adjustable strap lock lever 150 in the open position, the user then passes the first end 114 of the high-friction strap 110 through the first end aperture 142 of the adjustable strap lock base 140, wraps the first end 114 of the high-friction strap 110 around the first transverse bar 141 and passes the first end 114 of the high-friction strap 110 back through the two hole retaining clip 120 such that a strap loop is created between the two hole retaining clip 120 and the first end aperture 142 of the adjustable strap lock base 140. The two hole retaining clip 120 allows the length of the high-friction strap 110 to be adjusted to fit around garbage cans of different shapes and dimensions.

The bag binder system 100 is then configured in the open position as shown in FIG. 4. While in the open position, the user adjusts the length of the high-friction strap 110 to fit around the trash can using the two-hole retaining clip 120. While the adjustable strap lock lever 150 remains in the open position, the user then passes the second end 116 of the high-friction strap 110 first through the second end aperture 147 towards the bottom surface 148 of base plate 144 of adjustable strap lock base 140. Next, the second end 116 of the high-friction strap 110 is drawn across the bottom surface 148 of base plate 144 and through the middle aperture 145 of the adjustable strap lock base 140 up towards the indent 149 of the base plate 144. The user then passes the second end 116 of the high-friction strap 110 through the pass through opening of the adjustable strap lock assembly 130. In the open position, the pass through opening has sufficient clearance to allow the high-friction strap 110 to move easily in and out of the opening.

Next, the user pulls the second end 116 of the high-friction strap 110 until the high-friction strap 110 is in tension and fits tightly against the surface of the folded edge of the trash bag and outer surface of the trash can. Once adequate tension is created, the user rotates the strap lock lever 150 to the locked position as shown. As the user rotates the strap lock lever 150 to the locked position, the back curved surface 156 rotates away from the base plate 144 of the adjustable strap lock base 140 and the gripping end 158 beings to rotate towards the base plate 144. The base plate 144 has an indent 149 sized to receive the gripping end 158 of the adjustable lock lever with the surfaces of the indent 149 and the gripping end 158 separated by a predetermined distance. The predetermined distance defines the locking channel 167 and is smaller than the thickness of the high-friction strap 110. As the adjustable lock lever 150 is rotated into the locked position, the high-friction strap 110 is forced into the indent 149 of the base plate 144 by the gripping end 158 and compressed and prevented from moving, thereby maintaining the tension in the high-friction strap 110 and ensuring that the trash bag is properly bound to the trash can. The high-friction surface combined with the tension of the high-friction strap 110 firmly secures the trash bag to the trash can.

As shown, a portion of the high-friction strap 110 is disposed across the bottom surface 148 of the base plate 144 and a portion of the high-friction strap 110 is disposed on the underside of the first transverse bar 141. By disposing portions of the high-friction strap 110 along the underside of the adjustable strap lock assembly 130, the low-friction surface of the adjustable strap lock assembly 130 is covered with the high-friction surface of the high-friction strap 110. This maximizes the contact between the surface areas of the high-friction strap 110 with the trash bag and ensures adequate friction force is present to hold the trash bag in place, minimizing the possible points of failure due to the lower coefficient of friction of the adjustable strap lock assembly 130. Additionally, by disposing the high-friction strap 110 along the underside of the adjustable strap lock assembly 130, the tension created by the high-friction strap 110 will press the adjustable strap lock assembly 130 against the trash bag and trash can, thus sandwiching the portion of the high-friction strap 110 located on the underside of the adjustable strap lock assembly 130. The force will further prevent the high-friction strap 110 from slipping out of the adjustable strap lock assembly 130.

When the user wishes to take out the trash bag, the user simply rotates the strap lock lever 150 from the locked position to the open position, thereby creating the pass through opening. The tension of the high-friction strap 110 is released and a sufficient amount of the high-friction strap 110 can then pulled through the pass through opening to remove any remaining tension to enable the trash bag to be freely removed from the trash can.

Alternatively, because the high-friction strap 110 is elastic, a user can remove the Bag Binder without rotating the strap lock lever 150 from the locked position by simply stretching the high-friction strap 110 and then pulling the high-friction strap 110 over the outer lip 108 of the trash can 106. Because the high friction strap 110 has previously been adjusted to the appropriate length and held in place by the strap lock assembly 130, once a new trash bag 103 has been placed in the trash can 106, the user simply re-stretches the Bag Binder back over the outer lip 108 of the trash can 106 and then releases the high-friction strap 110. Once released by the user, the high-friction strap 110 will contract and securely hold the trash bag 102 against the outer surface 104 of trash can 106. This alternative method of changing a trash bag 102 without engaging the strap lock lever 150 allows a user to quickly change a trash bag 102 of a trash can 106 while retaining the benefits of the bag binder 100.

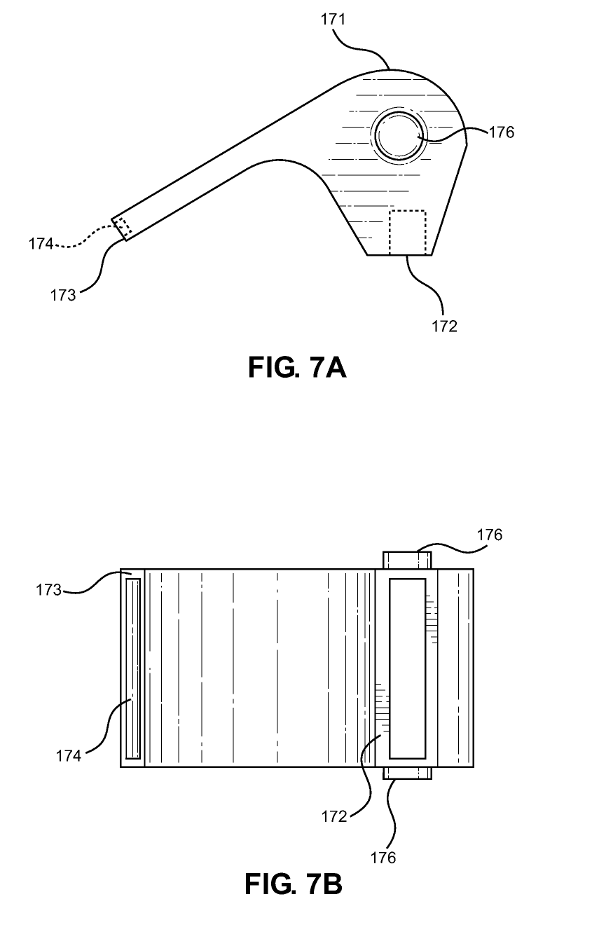

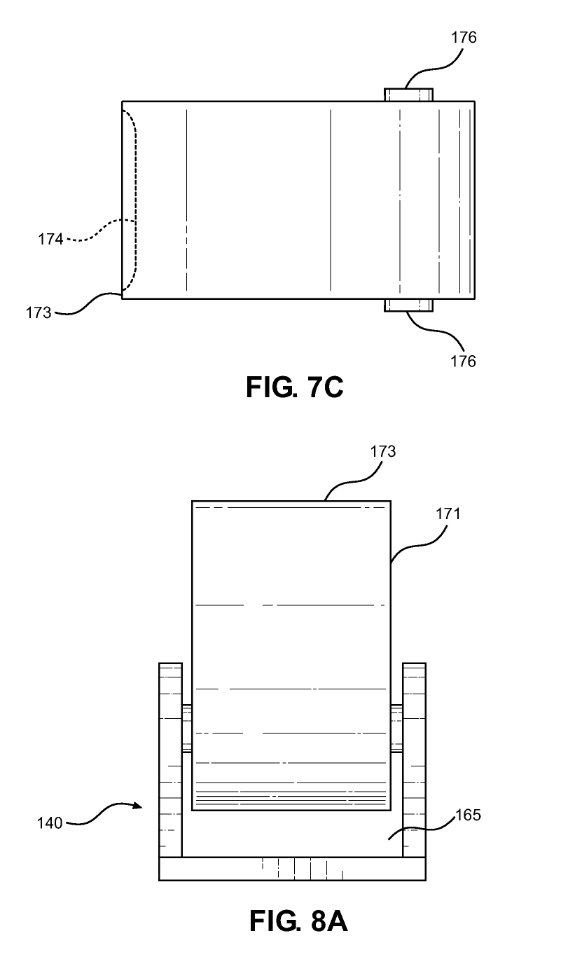

Referring now to FIGS. 7a through 7c, an alternative embodiment of the present invention is shown. Alternative strap lock assembly 170 consists of locking lever 171 having a flat gripping surface 172 and pegs 176, and a strap lock base 140. Located at the front end 173 of locking lever 171 is cut out 174. Cut out 174 provides a place for a user's fingernail or a tool to engage locking lever 171 thereby facilitating the ability to lift locking lever 171 away from strap lock base 140 to allow strap 110 to be adjusted or removed from around trash can 106. In operation, when locking lever 171 is rotated toward strap lock base 140, flat gripping surface 172 also rotates such that it comes into contact with strap 110, thereby providing a force strong enough to prevent strap 110 from becoming loose when secured around trash can 106. When in the locked position, the portion of locking lever 171 associated with cutout 174 comes into contact with strap lock base 140 thereby minimizing the exposure of any edge that may become caught causing locking lever 171 to disengage from strap 110 thereby allowing trash bag 102 to slip free and fall into trash can 106. It is to be appreciated by one skilled in the art that other embodiments of the Bag Binder may use a cutout to assist in the operation of the locking levers. To release high friction strap 110, allowing it to be adjusted or removed from trash can 106, locking lever 171 is rotated away from strap lock base 140 thereby disengaging flat gripping surface 172 from the high friction strap 110.

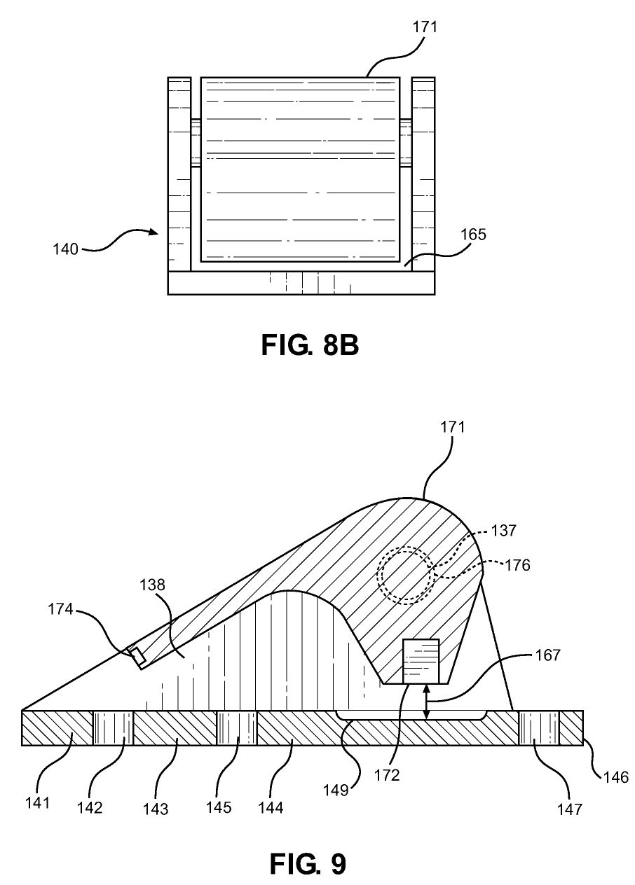

FIGS. 8a and 8b show a rear view of the adjustable strap lock assembly 130 with alternative locking lever 171 in the open position and locked position respectively. In the open position, the pass through opening 165 can be easily seen and is large enough to allow for a user to easily pass the second end 116 of the high friction strap 110 through the pass through opening 165. In the locked position, the pass through opening 165 is much reduced in size and also serves to secure the high friction strap 165 in addition to the locking channel 167 (not visible from FIG. 8b).

Lastly, FIG. 9 shows a cross sectional view of the adjustable strap lock with alternative locking lever 171. Locking lever 171 is shown in the locked position and forming a locking channel 167 where flat gripping surface 172 is in contact with strap 110 thereby holding strap 110 in place during use. It can be seen in this figure that the alternative design of locking lever 171 allows the cutout 174 portion of locking lever 171 to come into contact with strap lock base 140 thereby minimizing the possibility of locking lever 171 from becoming accidentally disengaged from strap 110 during use.

While there have been shown what are presently considered to be the preferred embodiment of the present invention, it will be apparent to those skilled in the art that various changes and modifications can be made herein without departing from the scope and spirit of the invention.

What I claim is:

1. A bag binder, comprising:
a strap having a first end and a second end;
an adjustable strap lock assembly with
a base having a first transverse bar, a second transverse bar and a base plate, each connected to a first support wall and a second support wall and a rear end connected to said base plate opposite said first transverse bar and said second transverse bar wherein said first transverse bar and said second transverse bar form a first end aperture, said rear end and said base plate form a second end aperture and said second transverse bar and said base plate form a middle aperture;
a locking lever having a top, a front end, a gripping end, a back end, and sides, said sides sized to fit between and rotatably connected to said first support wall and said second support wall of said base such that said locking lever can be rotated to an open position and a locked position with respect to said base;
a strap fastener;
wherein said first end of said strap is connected to said base through said first end aperture and is secured to said strap with said strap fastener; and
wherein said second end of said strap is connected to said base through said second aperture and locked in place by said gripping end of said locking lever.

2. The bag binder of claim 1, wherein said strap fastener is a retaining clip with a first hole and a second hole.

3. The bag binder of claim 1, wherein said first support wall and said second support wall each have a hole sized to receive a corresponding peg connected to each said side of said locking lever.

4. The bag binder of claim 1, wherein said base further comprises an indent such that a locking channel is formed when said locking lever is in said locked position.

5. The bag binder of claim 1, wherein said back end of said locking lever is configured to form a pass through opening when said locking lever is in said open position.

6. The bag binder of claim 1, wherein said gripping end has a textured surface.

7. The bag binder of claim 1 wherein said gripping end is flat.

8. The bag binder of claim 1 wherein said front end has a cut out.

9. The bag binder of claim 1 wherein said front end of said locking lever is angled with respect to said top of said top of said locking lever.

10. The bag binder of claim 1 where said strap is made from pliable rubber.

11. A bag binder, comprising:
a strap having a first end and a second end;
an adjustable strap lock assembly with
a base having a first transverse bar, a second transverse bar and a base plate with an indent, each connected to a first support wall and a second support wall and a rear end connected to said base plate opposite said first transverse bar and said second transverse bar wherein said first transverse bar and said second transverse bar form a first end aperture, said rear end and said base plate form a second end aperture and said second transverse bar and said base plate form a middle aperture;
a locking lever having a top, a front end, a gripping end, a back end, and sides, said sides sized to fit between and rotatably connected to said first support wall and said second support wall of said base such that said locking lever can be rotated to an open position and a locked position with respect to said base, and wherein said gripping end and said indent of said base plate form a locking channel when said locking lever is in said locked position and wherein said back end of said locking lever is configured to form a pass through opening when said locking lever is in said closed position;
a strap fastener;
wherein said first end of said strap is connected to said base through said first end aperture and is secured to said strap with said strap fastener; and
wherein said second end of said strap is connected to said base through said second aperture and locked in place by said gripping end of said locking lever.

12. The bag binder of claim 11 wherein said gripping end is flat.

13. The bag binder of claim 11 wherein said front end has a cut out.

14. The bag binder of claim 11 where said strap is made from pliable rubber.

15. The bag binder of claim 11, wherein said strap is made from material having a high coefficient of friction.

16. A method of using a bag binder comprising the steps of:
(a) providing a trash can with an interior and an exterior and a trash bag;
(b) inserting said trash bag into said trash can such that a portion of said trash bag is located on said exterior of said trash can;
(c) providing a bag binder comprising:
a strap having a first end and a second end;
an adjustable strap lock assembly with
a base having a first transverse bar, a second transverse bar and a base plate, each connected to a first support wall and a second support wall and a rear end connected to said base plate opposite said first transverse bar and said second transverse bar wherein said first transverse bar and said second transverse bar form a first end aperture, said rear end and said base plate form a second end aperture and said second transverse bar and said base plate form a middle aperture;
a locking lever having a top, a front end, a gripping end, a back end, and sides, said sides sized to fit between and rotatably connected to said first support wall and said second support wall of said base such that said locking lever can be rotated to an open position and a locked position with respect to said base;
a strap fastener;
wherein said first end of said strap is connected to said base through said first end aperture and is secured to said strap with said strap fastener; and
wherein said second end of said strap is connected to said base through said second aperture and locked in place by said gripping end of said locking lever.
(d) placing said locking lever in said open position;
(e) passing first end of said strap through said first end aperture of said strap lock assembly and connecting said first end of said strap to said strap using fastener;
(f) wrapping said strap around said portion of said trash bag on said exterior of said trash can such that said portion of said trash bag on said exterior is located between said exterior of said trash can and said strap;
(g) passing said second end of said strap through said second end aperture, through said middle aperture and between said base and said locking lever until said strap is in tension resulting in a force on said garbage bag and said garbage can sufficient to secure said garbage bag to said garbage can; and
(h) placing said locking lever in said locked position.

17. The method of claim 16 wherein said base of said bag binder further comprises an indent such that a locking channel is formed when said locking lever is in said locked position.

18. The method of claim 16 wherein said back end of said locking lever is configured to form a pass through opening when said locking lever is in said open position.

19. The method of claim 16 further comprising the steps of:
(i) placing said locking lever from said locked position to said open position;
(j) releasing said tension in said strap;
(k) removing said strap, said fastener and said strap lock assembly to enable a user to replace said trash bag.

20. The method of claim 16 further comprising the steps of:
(i) stretching said strap sufficiently to pull away from said garbage can and said garbage bag;
(j) replacing said trash bag with a new trash bag by inserting said new trash bag into said trash can such that a portion of said new trash bag is located on said exterior of said trash can;
(k) stretching said strap sufficiently to pull said strap over exterior of trash can such that said portion of said new trash bag is between said garbage can and said strap; and
(l) releasing said strap so as to enable said strap to apply said force on said portion of said new trash bag and said garbage can.
